(19) United States
(12) Patent Application Publication
(10) Pub. No.: US 2020/0205079 A1
(43) Pub. Date: Jun. 25, 2020

(54) WAKE-UP SIGNAL DURATION CONFIGURATION METHOD, WAKE-UP SIGNAL MONITORING METHOD, NETWORK DEVICE AND USER EQUIPMENT

(71) Applicants: China Mobile Communication Co., Ltd Research Institute, Beijing (CN); China Mobile Communications Group Co.,Ltd., Beijing (CN)

(72) Inventors: Hui TONG, Beijing (CN); Guang YANG, Beijing (CN)

(21) Appl. No.: 16/639,772

(22) PCT Filed: Jul. 27, 2018
(86) PCT No.: PCT/CN2018/097377

§ 371 Date: Feb. 18, 2020

(30) Foreign Application Priority Data
Aug. 18, 2017 (CN) 201710713348.9

(51) Int. Cl. H04W 52/02; H04W 4/70; H04W 72/04

(52) U.S. Cl. CPC H04W 52/0235; H04W 4/70; H04W 72/0446; H04W 72/042; H04W 52/0248

(57) ABSTRACT

The present disclosure provides a WUS duration configuration method, a WUS monitoring method, a network device and a UE. The WUS duration configuration method includes: generating configuration information including a duration of a WUS, the WUS being used to wake up an IoT UE, the duration being associated with one or more coverage parameters configured by a network device for the IoT UE; and transmitting the configuration information to the IoT UE.

### CROSS-REFERENCE TO RELATED APPLICATION

The present application claims a priority of the Chinese patent application No. 201710713348.9 filed on Aug. 18, 2017, which is incorporated herein by reference in its entirety.

### TECHNICAL FIELD

The present disclosure relates to the field of communication technology, in particular to a wake-up signal (WUS) duration configuration method, a WUS monitoring method, a network device, and a User Equipment (UE).

### BACKGROUND

For Internet of Things (IoT) services, a very long stand-by time is required, e.g., two AA batteries are provided so as to enable a UE to be in a standby mode for ten years. As speculated in a conventional Narrow Band-IoT (NB-IoT) standard, the UE may enter a long-term Discontinuous reception (DRX) state, so as to save energy. However, when the UE is in an energy-saving state, its delay for responding to a paging from a base station may increase. For some applications, e.g., bicycle-sharing applications, the user experience may be seriously adversely affected due to an increase in the delay.

In order to optimize the power consumption for the UE in the case of rapidly responding to the paging from the base station, such a concept as lightweight paging has been proposed in relevant standards, i.e., a lightweight signal (a WUS) is added before the detection of a paging signal. The UE may detect the paging signal subsequently only when the WUS has been detected. A relatively small volume of information is carried in the WUS, so it is able for the WUS to cover a cell merely through transmitting the WUS at few repetition times. In addition, when the UE is in an idle state, actually no paging message is transmitted at most of paging occasions. Hence, through the introduction of the WUS, it is able to remarkably reduce the power consumption for the UE.

The WUS needs to cover the entire cell, so it needs to be repeated several times. One mode includes directly configuring the repetition times (i.e., time-domain resources) for the WUS, which, however, results in a certain signaling overhead.

### SUMMARY

An object of the present disclosure is to provide a WUS duration configuration method, a WUS monitoring method, a network device, and a UE, so as to associate information about a WUS duration with an existing coverage configuration, thereby to enable the UE in different coverage ranges to detect WUSs with different durations.

In one aspect, the present disclosure provides a WUS duration configuration method, including: generating configuration information including a duration of a WUS, the WUS being used to wake up an IoT UE, the duration being associated with one or more coverage parameters configured by a network device for the IoT UE; and transmitting the configuration information to the IoT UE.

In some possible embodiments of the present disclosure, the duration is linearly associated with the one or more coverage parameters configured by the network device for the IoT UE.

In some possible embodiments of the present disclosure, the duration is [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the transmitting the configuration information to the IoT UE includes transmitting the configuration information to the IoT UE through transmitting indication information to the IoT UE.

In some possible embodiments of the present disclosure, the WUS duration configuration method further includes configuring a time interval configuration value between a time point when the WUS duration is ended and a time point when the detection of a physical downlink control channel for paging is started for the IoT UE.

In some possible embodiments of the present disclosure, the configuring the time interval configuration value between the time point when the WUS duration is ended and the time point when the detection of the control channel for the paging signal is started for the IoT UE includes: configuring the time interval configuration value between the time point when the WUS duration is ended and the time point when the detection of the control channel for the paging signal is started for the IoT UE through a broadcast message from the network device; or configuring the time interval configuration value between the time point when the WUS duration is ended and the time point when the detection of the control channel for the paging signal is started for the IoT UE through transmitting indication information to the IoT UE, the indication information carrying the time interval configuration value for the IoT UE; or configuring the time interval configuration value between the time point when the WUS duration is ended and the time point when the detection of the control channel for the paging signal is started for the IoT UE in accordance with a preset time interval configuration value between the time point when the WUS duration is ended and the time point when the detection of the control channel for the paging signal is started.

In some possible embodiments of the present disclosure, the WUS duration configuration method further includes configuring a start time-domain resource position where the acquisition of the WUS is started or an end time-domain resource position where the WUS duration is ended for the IoT UE.

In some possible embodiments of the present disclosure, the configuring the start time-domain resource position where the acquisition of the WUS is started or the end time-domain resource position where the WUS duration is ended for the IoT UE includes configuring the start time-domain resource position where the acquisition of the WUS is started or the end time-domain resource position where the WUS duration is ended for the IoT UE through the broadcast message from the network device or in a pre-configuration manner.

In another aspect, the present disclosure provides in some embodiments a network device, including: a processor configured to generate configuration information including a duration of a WUS, the WUS being used to wake up an IoT UE, the duration being associated with one or more coverage parameters configured by a network device for the IoT UE; and a transceiver configured to transmit the configuration information to the IoT UE.

In some possible embodiments of the present disclosure, the duration is linearly associated with the one or more coverage parameters configured by the network device for the IoT UE.

In some possible embodiments of the present disclosure, the duration is [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the transceiver is further configured to transmit the configuration information the IoT UE through transmitting indication information to the IoT UE.

In some possible embodiments of the present disclosure, the transceiver is further configured to configure a time interval configuration value between a time point when the WUS duration is ended and a time point when the detection of a physical downlink control channel for paging is started for the IoT UE.

In some possible embodiments of the present disclosure, the transceiver is further configured to: configure the time interval configuration value between the time point when the WUS duration is ended and the time point when the detection of the control channel for the paging signal is started for the IoT UE through a broadcast message from the network device; or configure the time interval configuration value between the time point when the WUS duration is ended and the time point when the detection of the control channel for the paging signal is started for the IoT UE through transmitting indication information to the IoT UE, the indication information carrying the time interval configuration value for the IoT UE; or configure the time interval configuration value between the time point when the WUS duration is ended and the time point when the detection of the control channel for the paging signal is started for the IoT UE in accordance with a preset time interval configuration value between the time point when the WUS duration is ended and the time point when the detection of the control channel for the paging signal is started.

In some possible embodiments of the present disclosure, the transceiver is further configured to configure a start time-domain resource position where the acquisition of the WUS is started or an end time-domain resource position where the WUS duration is ended for the IoT UE.

In some possible embodiments of the present disclosure, the transceiver is further configured to configure the start time-domain resource position where the acquisition of the WUS is started or the end time-domain resource position where the WUS duration is ended for the IoT UE through the broadcast message from the network device or in a pre-configuration manner.

In yet another aspect, the present disclosure provides in some embodiments a WUS monitoring method, including: receiving configuration information including a duration of a WUS from a network device, the WUS being used to wake up an IoT UE, the duration being associated with one or more coverage parameters configured by a network device for the IoT UE; and monitoring the WUS in accordance with the configuration information.

In some possible embodiments of the present disclosure, the duration is linearly associated with the one or more coverage parameters configured by the network device for the IoT UE.

In some possible embodiments of the present disclosure, the duration is [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the receiving the configuration information including the duration of the WUS from the network device includes acquiring the configuration information including the duration of the WUS through receiving indication information from the network device.

In some possible embodiments of the present disclosure, the WUS monitoring method further includes receiving a time interval configuration value between a time point when the WUS duration is ended and a time point when the detection of a physical downlink control channel for paging is started configured by the network device for the IoT UE.

In some possible embodiments of the present disclosure, the receiving the time interval configuration value between the time point when the WUS duration is ended and the time point when the detection of the control channel for the paging signal is started configured by the network device for the IoT UE includes receiving the time interval configuration value between the time point when the WUS duration is ended and the time point when the detection of the control channel for the paging signal is started configured for the IoT UE through receiving a broadcast message from the network device, or receiving indication information from the network device, or in accordance with a preset time interval configuration value between the time point when the WUS duration is ended and the time point when the detection of the control channel for the paging signal is started.

In some possible embodiments of the present disclosure, the WUS monitoring method further includes acquiring a start time-domain resource position where the acquisition of the WUS is started or an end time-domain resource position where the WUS duration is ended configured for the IoT UE.

In some possible embodiments of the present disclosure, the acquiring the start time-domain resource position where the acquisition of the WUS is started or the end time-domain resource position where the WUS duration is ended configured for the IoT UE includes acquiring the start time-domain resource position where the acquisition of the WUS is started or the end time-domain resource position where the WUS duration is ended configured for the IoT UE through the broadcast message from the network device or in a pre-configuration manner.

In some possible embodiments of the present disclosure, the WUS monitoring method further includes: monitoring the WUS from the start time-domain resource position; and/or stopping the acquisition of the WUS at the end time-domain resource position or at L symbols before the end time-domain resource position, where L is configured by the network device through broadcasting or preset.

In still yet another aspect, the present disclosure provides in some embodiments a UE, including a transceiver configured to: receive configuration information including a duration of a WUS from a network device, the WUS being used to wake up an IoT UE, the duration being associated with one or more coverage parameters configured by a network device for the IoT UE; and acquire the WUS in accordance with the configuration information.

In some possible embodiments of the present disclosure, the duration is linearly associated with the one or more coverage parameters configured by the network device for the IoT UE.

In some possible embodiments of the present disclosure, the duration is [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the transceiver is further configured to acquire the configuration information including the duration of the WUS through receiving indication information from the network device.

In some possible embodiments of the present disclosure, the transceiver is further configured to receive a time interval configuration value between a time point when the WUS duration is ended and a time point when the detection of a physical downlink control channel for paging is started configured by the network device for the IoT UE.

In some possible embodiments of the present disclosure, the transceiver is further configured to receive the time interval configuration value between the time point when the WUS duration is ended and the time point when the detection of the control channel for the paging signal is started configured for the IoT UE through receiving a broadcast message from the network device, or receiving indication information from the network device, or in accordance with a preset time interval configuration value between the time point when the WUS duration is ended and the time point when the detection of the control channel for the paging signal is started.

In some possible embodiments of the present disclosure, the transceiver is further configured to acquire a start time-domain resource position where the acquisition of the WUS is started or an end time-domain resource position where the WUS duration is ended configured for the IoT UE.

In some possible embodiments of the present disclosure, the transceiver is further configured to acquire the start time-domain resource position where the acquisition of the WUS is started or the end time-domain resource position where the WUS duration is ended configured for the IoT UE through the broadcast message from the network device or in a pre-configuration manner.

In some possible embodiments of the present disclosure, the transceiver is further configured to: acquire the WUS from the start time-domain resource position; and/or stop the acquisition of the WUS at the end time-domain resource position or at L symbols before the end time-domain resource position, where L is configured by the network device through broadcasting or preset.

In still yet another aspect, the present disclosure provides in some embodiments a communication device, including a processor and a memory storing therein a computer program. The processor is configured to execute the computer program so as to implement the above-mentioned WUS duration configuration method or WUS monitoring method.

In still yet another aspect, the present disclosure provides in some embodiments a computer-readable storage medium storing therein a computer program instruction. The computer program instruction is executed by a computer so as to implement the above-mentioned WUS duration configuration method or WUS monitoring method.

The present disclosure at least has the following beneficial effect. According to the embodiments of the present disclosure, the configuration information including the duration of the WUS may be generated, the WUS may be used to wake up the IoT UE, and the duration may be associated with the one or more coverage parameters configured by the network device for the IoT UE. Then, the configuration information may be transmitted to the IoT UE, so that the IoT UE may acquire the WUS in accordance with the configuration information. As a result, it is able to associate the duration of the WUS with an existing coverage configuration, thereby to enable the UE in different coverage ranges to acquire the WUSs with different durations.

### BRIEF DESCRIPTION OF THE DRAWINGS

FIG. 1 is a flow chart of a WUS duration configuration method according to some embodiments of the present disclosure;

FIG. 2 is another flow chart of the WUS duration configuration method according to some embodiments of the present disclosure;

FIG. 3 is a schematic view showing a time interval reserved between a time point when the WUS duration is ended and a time point when the detection of a physical downlink control channel for paging is started according to some embodiments of the present disclosure;

FIG. 4 is another flow chart of the WUS duration configuration method according to some embodiments of the present disclosure; and

FIG. 5 is a schematic view showing a start time-domain resource position where the acquisition of the WUS is started and an end time-domain resource position where the WUS duration is ended according to some embodiments of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure. Actually, the embodiments are provided so as to facilitate the understanding of the scope of the present disclosure.

In some embodiments of the present disclosure, a duration of a WUS may be associated with an existing coverage configuration. When a channel is repeated at relatively larger repetition times, it may take a longer time for an IoT UE to acquire the duration of the WUS, and when the channel is repeated at relatively smaller repetition times, it may take a shorter time for the IoT UE to acquire the duration of the WUS.

In addition, the IoT UE has a relatively low complexity, and after the acquisition of the WUS, it needs to take a certain time period for the IoT UE to perform subsequent signal processing. When the WUS indicating that there is a paging has indeed been detected, the IoT UE may activate the other circuits for the paging. Hence, there is a time interval between an end time-domain resource position where the WUS duration is ended and a time point when the detection of a paging signal is started. A value of the time interval may be configured by a base station, or specified in the standard.

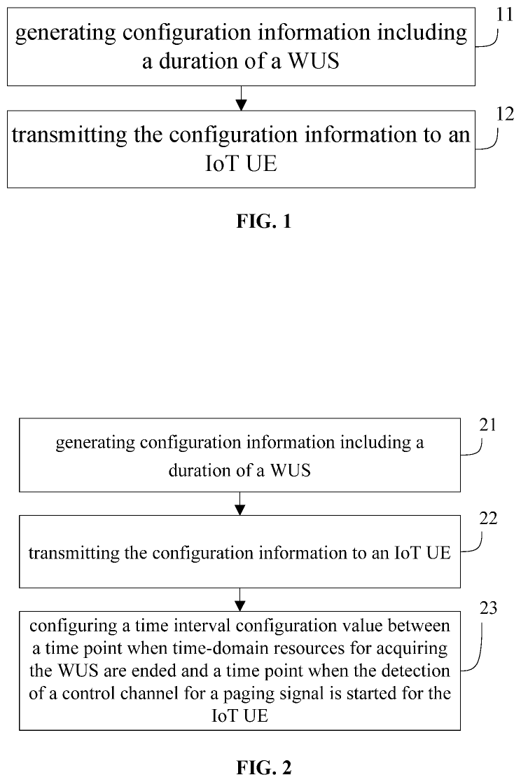

As shown in FIG. 1, the present disclosure provides in some embodiments a WUS duration configuration method for a network device which includes: Step 11 of generating configuration information including a duration of a WUS, the WUS being used to wake up an IoT UE, the duration being associated with one or more coverage parameters configured by the network device for the IoT UE; and Step 12 of transmitting the configuration information to the IoT UE.

According to the embodiments of the present disclosure, the configuration information including the duration of the WUS may be generated, the WUS may be used to wake up the IoT UE, and the duration may be associated with the one or more coverage parameters configured by the network device for the IoT UE. Then, the configuration information may be transmitted to the IoT UE, so that the IoT UE may acquire the WUS in accordance with the configuration information. As a result, it is able to associate the duration of the WUS with an existing coverage configuration, thereby to enable the UE in different coverage ranges to acquire the WUSs with different durations.

In the embodiments of the present disclosure, the duration may be linearly associated with the one or more coverage parameters configured by the network device for the IoT UE.

To be specific, the duration may be [A/M]+K, where [] represents a rounding operation including a rounding-up operation or a rounding-down operation, A represents the coverage parameter, K is equal to 0 or a predetermined value other than 0, M represents a predetermined constant.

The one or more coverage parameters may include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

As shown in FIG. 2, the present disclosure further provides in some embodiments a WUS duration configuration method for a network device which includes: Step 21 of generating configuration information including a duration of a WUS, the WUS being used to wake up an IoT UE, the duration being associated with one or more coverage parameters configured by the network device for the IoT UE; Step 22 of transmitting the configuration information to the IoT UE; and Step 23 of configuring a time interval configuration value between a time point when time-domain resources for monitoring the WUS are ended and a time point when the detection of a physical downlink control channel for paging is started for the IoT UE.

To be specific, Step 23 may include: Step 231 of configuring the time interval configuration value between the time point when the time-domain resources for monitoring the WUS are ended and the time point when the detection of the control channel for the paging signal is started for the IoT UE through a broadcast message from the network device; or Step 232 of configuring the time interval configuration value between the time point when the time-domain resources for monitoring the WUS are ended and the time point when the detection of the control channel for the paging signal is started for the IoT UE through transmitting indication information to the IoT UE, the indication information carrying the time interval configuration value for the IoT UE; or Step 233 of configuring the time interval configuration value between the time point when the time-domain resources for monitoring the WUS are ended and the time point when the detection of the control channel for the paging signal is started for the IoT UE in accordance with a preset time interval configuration value between the time point when the WUS duration is ended and the time point when the detection of the control channel for the paging signal is started.

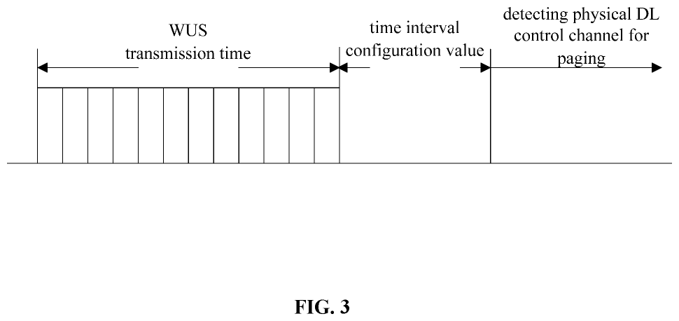

To be specific, as shown in FIG. 3, there is a time interval between the time point when the time-domain resources for monitoring the WUS are ended and the time point when the detection of the control channel for the paging signal is started. A specific value of the time interval may be broadcast by a base station and configured at a cell level, or configured by the base station at an UE level, or specified in the standard.

According to the embodiments of the present disclosure, the configuration information including the duration of the WUS may be generated, the WUS may be used to wake up the IoT UE, and the duration may be associated with the one or more coverage parameters configured by the network device for the IoT UE. Then, the configuration information may be transmitted to the IoT UE, and the time interval configuration value between the time point when the time-domain resources for monitoring the WUS are ended and the time point when the detection of the control channel for the paging signal is started may be configured for the IoT UE, so that the IoT UE may acquire the WUS in accordance with the configuration information. In addition, after the acquisition of the WUS, it needs to take a certain time period for the IoT UE to perform subsequent signal processing. When the WUS indicating that there is a paging has indeed been detected, the IoT UE may activate the other circuits for the paging. As a result, it is able to associate the duration of the WUS with an existing coverage configuration, thereby to enable the UE in different coverage ranges to acquire the WUSs with different durations.

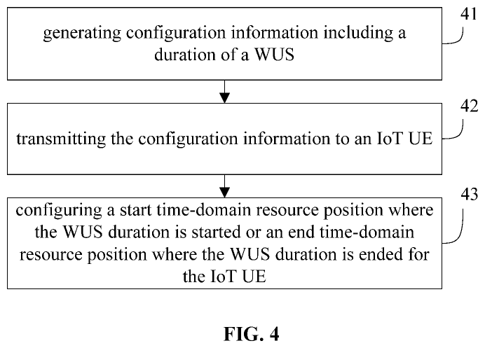

As shown in FIG. 4, the present disclosure further provides in some embodiments a WUS duration configuration method which includes: Step 41 of generating configuration information including a duration of a WUS, the WUS being used to wake up an IoT UE, the duration being associated with one or more coverage parameters configured by a network device for the IoT UE; Step 42 of transmitting the configuration information to the IoT UE; and Step 43 of configuring a start time-domain resource position where the acquisition of the WUS is started or an end time-domain resource position where the WUS duration is ended for the IoT UE.

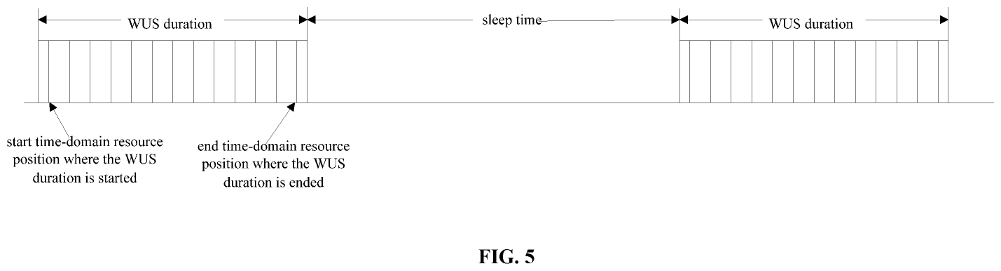

To be specific, as shown in FIG. 5, the start time-domain resource position where the acquisition of the WUS is started or the end time-domain resource position where the WUS duration is ended may be configured for the IoT UE through a broadcast message from the network device or in a pre-configuration manner. In some possible embodiments of the present disclosure, the IoT UE may start to acquire the WUS at the start time-domain resource position, or stop the acquisition of the WUS at the end time-domain resource position or stop the acquisition of the WUS at L symbols before the end time-domain resource position, where L may be configured by the network device through broadcasting or preset.

According to the embodiments of the present disclosure, the configuration information including the duration of the WUS may be generated, the WUS may be used to wake up the IoT UE, and the duration may be associated with the one or more coverage parameters configured by the network device for the IoT UE. Then, the configuration information may be transmitted to the IoT UE, and the start time-domain resource position where the acquisition of the WUS is started and the end time-domain resource position where the WUS duration is ended may be configured for the IoT UE, so that the IoT UE may acquire the WUS or stop the acquisition of the WUS in accordance with the configuration information. As a result, it is able for the IoT UE in different coverage ranges to acquire the WUSs with different durations.

As mentioned above, the WUSs with different durations may be configured for the UE, and each duration may be associated with the coverage parameter configured by the network device. In this way, in the case that a set of WUSs has been transmitted by the base station, it is able for the UE in different coverage ranges to acquire the WUSs with different durations.

The present disclosure further provides in some embodiments a network device, including: a processor configured to generate configuration information including a duration of a WUS, the WUS being used to wake up an IoT UE, the duration being associated with one or more coverage parameters configured by the network device for the IoT UE; and a transceiver configured to transmit the configuration information to the IoT UE.

In some possible embodiments of the present disclosure, the duration may be linearly associated with the one or more coverage parameters configured by the network device for the IoT UE.

In some possible embodiments of the present disclosure, the duration may be [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters may include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the transceiver is further configured to transmit the configuration information the IoT UE through transmitting indication information to the IoT UE.

In some possible embodiments of the present disclosure, the transceiver is further configured to configure a time interval configuration value between a time point when the WUS duration is ended and a time point when the detection of a physical downlink control channel for paging is started for the IoT UE.

In some possible embodiments of the present disclosure, the transceiver is further configured to: configure the time interval configuration value between the time point when the WUS duration is ended and the time point when the detection of the control channel for the paging signal is started for the IoT UE through a broadcast message from the network device; or configure the time interval configuration value between the time point when the WUS duration is ended and the time point when the detection of the control channel for the paging signal is started for the IoT UE through transmitting indication information to the IoT UE, the indication information carrying the time interval configuration value for the IoT UE; or configure the time interval configuration value between the time point when the WUS duration is ended and the time point when the detection of the control channel for the paging signal is started for the IoT UE in accordance with a preset time interval configuration value between the time point when the WUS duration is ended and the time point when the detection of the control channel for the paging signal is started.

In some possible embodiments of the present disclosure, the transceiver is further configured to configure a start time-domain resource position where the acquisition of the WUS is started or an end time-domain resource position where the WUS duration is ended for the IoT UE.

In some possible embodiments of the present disclosure, the transceiver is further configured to configure the start time-domain resource position where the acquisition of the WUS is started or the end time-domain resource position where the WUS duration is ended for the IoT UE through the broadcast message from the network device or in a pre-configuration manner.

In the embodiments of the present disclosure, the network device may be a device corresponding to the above-mentioned method, and it may be a base station or any other device at a network side. The implementation of the network device may refer to that of the method mentioned hereinabove, with a same technical effect.

The present disclosure further provides in some embodiments a WUS monitoring method for an IoT UE, including: receiving configuration information including a duration of a WUS from a network device, the WUS being used to wake up the IoT UE, the duration being associated with one or more coverage parameters configured by a network device for the IoT UE; and monitoring the WUS in accordance with the configuration information.

In some possible embodiments of the present disclosure, the duration may be linearly associated with the one or more coverage parameters configured by the network device for the IoT UE.

In some possible embodiments of the present disclosure, the duration may be [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters may include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the receiving the configuration information including the duration of the WUS from the network device may include acquiring the configuration information including the duration of the WUS through receiving indication information from the network device.

In some possible embodiments of the present disclosure, the WUS monitoring method may further include receiving a time interval configuration value between a time point when the WUS duration is ended and a time point when the detection of a physical downlink control channel for paging is started configured by the network device for the IoT UE.

In some possible embodiments of the present disclosure, the receiving the time interval configuration value between the time point when the WUS duration is ended and the time point when the detection of the control channel for the paging signal is started configured by the network device for the IoT UE may include receiving the time interval configuration value between the time point when the WUS duration is ended and the time point when the detection of the control channel for the paging signal is started configured for the IoT UE through receiving a broadcast message from the network device, or receiving indication information from the network device, or in accordance with a preset time interval configuration value between the time point when the WUS duration is ended and the time point when the detection of the control channel for the paging signal is started.

In some possible embodiments of the present disclosure, the WUS monitoring method may further include acquiring a start time-domain resource position where the acquisition of the WUS is started or an end time-domain resource position where the WUS duration is ended configured for the IoT UE.

In some possible embodiments of the present disclosure, the acquiring the start time-domain resource position where the acquisition of the WUS is started or the end time-domain resource position where the WUS duration is ended configured for the IoT UE may include acquiring the start time-domain resource position where the acquisition of the WUS is started or the end time-domain resource position where the WUS duration is ended configured for the IoT UE through the broadcast message from the network device or in a pre-configuration manner.

In some possible embodiments of the present disclosure, the WUS monitoring method may further include: monitoring the WUS from the start time-domain resource position; and/or stopping the acquisition of the WUS at the end time-domain resource position or at L symbols before the end time-domain resource position, where L is configured by the network device through broadcasting or preset.

According to the embodiments of the present disclosure, the UE may acquire the configuration information, and acquire the WUS in accordance with the configuration information. As a result, in the case that a set of WUSs have been transmitted by the base station, it is able for the UE in different coverage ranges to acquire the WUSs with different durations.

The present disclosure further provides in some embodiments a UE, including: a transceiver configured to: receive configuration information including a duration of a WUS from a network device, the WUS being used to wake up an IoT UE, the duration being associated with one or more coverage parameters configured by a network device for the IoT UE; and acquire the WUS in accordance with the configuration information.

In some possible embodiments of the present disclosure, the duration may be linearly associated with the one or more coverage parameters configured by the network device for the IoT UE.

In some possible embodiments of the present disclosure, the duration may be [A/M]+K, where [] represents a rounding operation including a rounding-up operation or a rounding-down operation, A represents the coverage parameter, K is equal to 0 or a predetermined value other than 0, M represents a predetermined constant.

In some possible embodiments of the present disclosure, the one or more coverage parameters may include maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

In some possible embodiments of the present disclosure, the transceiver is further configured to acquire the configuration information including the duration of the WUS through receiving indication information from the network device.

In some possible embodiments of the present disclosure, the transceiver is further configured to receive a time interval configuration value between a time point when the WUS duration is ended and a time point when the detection of a physical downlink control channel for paging is started configured by the network device for the IoT UE.

In some possible embodiments of the present disclosure, the transceiver is further configured to receive the time interval configuration value between the time point when the WUS duration is ended and the time point when the detection of the control channel for the paging signal is started configured for the IoT UE through receiving a broadcast message from the network device, or receiving indication information from the network device, or in accordance with a preset time interval configuration value between the time point when the WUS duration is ended and the time point when the detection of the control channel for the paging signal is started.

In some possible embodiments of the present disclosure, the transceiver is further configured to acquire a start time-domain resource position where the acquisition of the WUS is started or an end time-domain resource position where the WUS duration is ended configured for the IoT UE.

In some possible embodiments of the present disclosure, the transceiver is further configured to acquire the start time-domain resource position where the acquisition of the WUS is started or the end time-domain resource position where the WUS duration is ended configured for the IoT UE through the broadcast message from the network device or in a pre-configuration manner.

In some possible embodiments of the present disclosure, the transceiver is further configured to: acquire the WUS from the start time-domain resource position; and/or stop the acquisition of the WUS at the end time-domain resource position or at L symbols before the end time-domain resource position, where L is configured by the network device through broadcasting or preset.

In the embodiments of the present disclosure, the UE may be a device corresponding to the above-mentioned method for the UE, and the implementation of the UE may refer to that of the method mentioned hereinabove, with a same technical effect.

The present disclosure further provides in some embodiments a communication device, including a processor and a memory storing therein a computer program. The processor is configured to execute the computer program so as to implement the above-mentioned WUS duration configuration method or WUS monitoring method. The processor may be coupled to the memory via an interface or a bus. The communication device may be the above-mentioned network device, e.g., a base station, or the above-mentioned UE, e.g., an IoT UE.

The present disclosure further provides in some embodiments a computer-readable storage medium storing therein a computer program instruction. The computer program instruction is executed by a computer so as to implement the above-mentioned WUS duration configuration method or WUS monitoring method.

The computer-readable storage medium may be a volatile computer-readable storage medium or a non-volatile computer-readable storage medium, or a transient computer-readable storage medium or a non-transient computer-readable storage medium.

According to the embodiments of the present disclosure, the WUSs with different durations may be configured for the UE, and each duration may be associated with the coverage parameter configured by the network device. As a result, in the case that a set of WUSs have been transmitted by the base station, it is able for the UE in different coverage ranges to acquire the WUSs with different durations.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A Wake-Up Signal (WUS) duration configuration method, comprising:
generating configuration information comprising a duration of a WUS, the WUS being used to wake up an Internet of Things (IoT) User Equipment (UE), the duration being associated with one or more coverage parameters configured by a network device for the IoT UE; and
transmitting the configuration information to the IoT UE.

2. The WUS duration configuration method according to claim 1, wherein the duration is linearly associated with the one or more coverage parameters configured by the network device for the IoT UE.

3. The WUS duration configuration method according to claim 2, wherein the duration is [A/M]+K, where [] represents a rounding operation comprising a rounding-up operation or a rounding-down operation, A represents the coverage parameter, K is equal to 0 or a predetermined value other than 0, M represents a predetermined constant.

4. The WUS duration configuration method according to claim 1, wherein the one or more coverage parameters comprise maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

5. The WUS duration configuration method according to claim 1, wherein the transmitting the configuration information to the IoT UE comprises: transmitting the configuration information to the IoT UE through transmitting indication information to the IoT UE.

6. The WUS duration configuration method according to claim 1, further comprising:
configuring a time interval configuration value between a time point when the WUS duration is ended and a time point when the detection of a physical downlink control channel for paging is started for the IoT UE.

7. The WUS duration configuration method according to claim 6, wherein the configuring the time interval configuration value between the time point when the WUS duration is ended and the time point when the detection of the control channel for the paging signal is started for the IoT UE comprises:
configuring the time interval configuration value between the time point when the WUS duration is ended and the time point when the detection of the control channel for the paging signal is started for the IoT UE through a broadcast message from the network device; or
configuring the time interval configuration value between the time point when the WUS duration is ended and the time point when the detection of the control channel for the paging signal is started for the IoT UE through transmitting indication information to the IoT UE, the indication information carrying the time interval configuration value for the IoT UE; or
configuring the time interval configuration value between the time point when the WUS duration is ended and the time point when the detection of the control channel for the paging signal is started for the IoT UE in accordance with a preset time interval configuration value between the time point when the WUS duration is ended and the time point when the detection of the control channel for the paging signal is started.

8. The WUS duration configuration method according to claim 1, further comprising:
a start time-domain resource position where the acquisition of the WUS is started or an end time-domain resource position where the WUS duration is ended for the IoT UE.

9. The WUS duration configuration method according to claim 8, wherein the configuring the start time-domain resource position where the acquisition of the WUS is started or the end time-domain resource position where the WUS duration is ended for the IoT UE comprises:
configuring the start time-domain resource position where the acquisition of the WUS is started or the end time-domain resource position where the WUS duration is ended for the IoT UE through the broadcast message from the network device or in a pre-configuration manner.

10. A network device, comprising:
a processor configured to generate configuration information comprising a duration of a WUS, the WUS being used to wake up an IoT UE, the duration being associated with one or more coverage parameters configured by a network device for the IoT UE; and
a transceiver configured to transmit the configuration information to the IoT UE.

11-18. (canceled)

19. A Wake-Up Signal (WUS) monitoring method, comprising:
receiving configuration information comprising a duration of a WUS from a network device, the WUS being used to wake up an IoT UE, the duration being associated with one or more coverage parameters configured by a network device for the IoT UE; and
monitoring the WUS in accordance with the configuration information.

20. The WUS monitoring method according to claim 19, wherein the duration is linearly associated with the one or more coverage parameters configured by the network device for the IoT UE.

21. The WUS monitoring method according to claim 20, wherein the duration is [A/M]+K, where [] represents a rounding operation comprising a rounding-up operation or a rounding-down operation, A represents the coverage parameter, K is equal to 0 or a predetermined value other than 0, M represents a predetermined constant.

22. The WUS monitoring method according to claim 19, wherein the one or more coverage parameters comprise maximum number of repetitions of a physical downlink control channel for paging, maximum number of repetitions of a data scheduling control channel, maximum number of repetitions of a control channel for transmitting Msg2 in a random access procedure, and/or maximum number of repetitions of a control channel for transmitting Msg4 in the random access procedure.

23. The WUS monitoring method according to claim 19, wherein the receiving the configuration information comprising the duration of the WUS from the network device comprises:
acquiring the configuration information comprising the duration of the WUS through receiving indication information from the network device.

24. The WUS monitoring method according to claim 19, further comprising:
receiving a time interval configuration value between a time point when the WUS duration is ended and a time point when the detection of a physical downlink control channel for paging is started, wherein the time interval value is configured by the network device for the IoT UE.

25. The WUS monitoring method according to claim 24, wherein the receiving the time interval configuration value between the time point when the WUS duration is ended and the time point when the detection of the control channel for the paging signal is started, wherein the time interval value is configured by the network device for the IoT UE comprises:
receiving the time interval configuration value between the time point when the WUS duration is ended and the time point when the detection of the control channel for the paging signal is started configured for the IoT UE through receiving a broadcast message from the network device, or receiving indication information from the network device, or in accordance with a preset time interval configuration value between the time point when the WUS duration is ended and the time point when the detection of the control channel for the paging signal is started.

26. The WUS monitoring method according to claim 19, further comprising:
acquiring a start time-domain resource position where the acquisition of the WUS is started or an end time-domain resource position where the WUS duration is ended configured for the IoT UE.

27. The WUS monitoring method according to claim 26, wherein the acquiring the start time-domain resource position where the acquisition of the WUS is started or the end time-domain resource position where the WUS duration is ended configured for the IoT UE comprises:
acquiring the start time-domain resource position where the acquisition of the WUS is started or the end time-domain resource position where the WUS duration is ended configured for the IoT UE through the broadcast message from the network device or in a pre-configuration manner,
wherein the WUS monitoring method further comprises:
monitoring the WUS from the start time-domain resource position; and/or
stopping the acquisition of the WUS at the end time-domain resource position or at L symbols before the end time-domain resource position, where L is configured by the network device through broadcasting or preset.

28-38. (canceled)

39. A User Equipment (UE), comprising a processor and a memory storing therein a computer program, wherein the processor is configured to execute the computer program so as to implement the WUS monitoring method according to claim 19.

40. (canceled)
